(19) United States
(12) Patent Application Publication
(10) Pub. No.: US 2005/0194569 A1
(43) Pub. Date: Sep. 8, 2005

(54) Compound based on liquid crystals for making optoelectronic components and corresponding manufacturing process

(75) Inventors: Pascal Gautier, Brest (FR); Eric Salun, Brest (FR); Jean-Louis De Bougrenet De La Tocnaye, Guilers (FR); Roman Dabrowski, Varsovie (PL)

Correspondence Address: MERCHANT & GOULD PC, P.O. BOX 2903, MINNEAPOLIS, MN, 55402-0903, US

(73) Assignee: OPTOGONE, PLOUZANE (FR)

(21) Appl. No.: 11/071,142

(22) Filed: Mar. 3, 2005

(30) Foreign Application Priority Data
Mar. 4, 2004 (FR) 04 02291

(51) Int. Cl. C09K 19/12; C09K 19/52; C09K 19/38; C09K 19/20

(52) U.S. Cl. 252/299.66; 252/299.01; 252/299.67

(57) ABSTRACT

This invention relates to a compound based on liquid crystals for making optoelectronic components. According to the invention, this compound comprises at least one cyanoester, at least one isothiocyanobiphenyl and at least one monomer.

### DOMAIN OF THE INVENTION

The invention relates to the design and manufacture of optoelectronic components for telecommunications.

More precisely, the invention relates to a process for manufacturing a compound based on liquid crystals for insertion into an optoelectronic component.

### SOLUTIONS ACCORDING TO PRIOR ART

In particular, the domain of optical telecommunications imposes strict constraints on operating and storage temperatures of its components. In particular, the Tellcordia standard GR-1209 dedicated to passive components recommends the following temperature ranges:
from −10° C. to 60° C. for operation,
from 5° C. to 40° C. for operation in onboard systems, and
from −40° C. to 70° C. for storage.

The optical components on which the invention is concentrated are made using a compound including a combination of at least one liquid crystal (nematic or smectic) and polymers and are known under the name of PDLC (polymer dispersed liquid crystal). These compounds are electro-optic materials. Their optical properties, and particularly the value of their refraction index, can thus be modified by applying an electrical field to them. A distinction is made between PDLCs and nano-PDLCs, the main difference being a result of the size of the liquid crystal droplets encapsulated in the polymer matrix. For nano-PDLCs, the droplet size of the order of a few tens of nanometres to a few hundreds of nanometres (typically from 50 nm to 200 nm) is smaller than the droplet size for PDLCs, which is of the order of a few microns (typically 0.5 microns to 4 microns) as was indicated particularly in the American patent published as number U.S. Pat. No. 4,688,900.

It is well known that the properties of these components, and particularly properties related to the liquid crystal based compound, are closely dependent on the operating temperature. After seeing the operating temperature ranges mentioned above, one classical solution for reducing the variations of the properties of these components with temperature is to use a Peltier module, or more generally a voltage controlled electronic temperature regulation device. This solution stabilises the temperature of the component independently of the temperature of the medium in which it is placed.

However, this classical solution uses an additional command layer and therefore has the disadvantage of increasing the volume and cost of components.

Another solution for reducing fluctuations in the properties of the liquid crystal based compound with temperature, without increasing the volume and cost of components, is to make these properties stable under varying temperatures.

Properties of liquid crystals are made stable under varying temperatures (athermalisation) for some applications, and a number of compounds are commercially available.

A combination with a matrix of polymer introduces an additional compatibility constraint. The choice of the monomer and the polymerisation process can have an effect on the characteristics of these liquid crystals, in particular by changing their temperature ranges within which their properties are stable (as indicated particularly in the article “PDLC films for light control applications” written by G. P. Montgomery and published in the LC Chemistry, Physics and Applications Proceedings of the SPIE journal, volume 1080 on pages 242 to 249, in 1989). Therefore, there is a problem in finding the right liquid crystal/monomer pair and the right manufacturing process, including the use of photoinitiators. The concentration of liquid crystals is also an important factor.

Compounds providing solutions to these problems have been found in the automobile industry. PDLCs with fairly long operating and storage temperature ranges have been used in this domain (as indicated particularly in American patent document published as number U.S. Pat. No. 5,004,323).

However, to be used in the telecommunications domain, this type of PDLC compounds must have very wide operating and storage temperature ranges as mentioned above.

Another problem that arises is to assure that the monomer-liquid crystal pair and the manufacturing process do not introduce undesirable secondary effects (reduction of the attenuation or phase shift range, reduction in response times, abusive increase in control voltages, etc.). The weight assigned to each of these parameters can result in variable and specific combinations.

In the case of the automobile industry for which the important parameters are the attenuation range/control voltage pair and the response time, compounds have been found for which the values of these parameters are stable within relatively wide temperature ranges (particularly as indicated in PCT patent application published as number WO03035798).

In the telecommunications context, one important parameter other than attenuation and phase shift ranges, is the PDL (Polarisation Dependent Loss). It is defined as being the difference in decibels between the maximum value and the minimum value of losses due to the variation of the polarisation states of a light beam propagating in a component. It is known that cross-linking of the monomer during the polymerisation phase can have an impact on the geometry of droplets and consequently on the anisotropy of the compound.

Another important parameter is the response time of the compound. Two response times can be defined for a compound, namely the rise time and the fall time. The fall time is defined as being the time spent, when an electric field is applied to the compound, for the liquid crystal molecules to orient themselves such that the attenuation of an optical signal passing through the compound changes from 90% to 10% of the attenuation without the field. The rise time is defined as being the time spent, when an electrical field already applied to the compound is removed, for the liquid crystal molecules to leave their orientation such that the attenuation of an optical signal passing through the compound changes from 10% to 90% of the attenuation without the field.

### PURPOSES OF THE INVENTION

In particular, the purpose of the invention is to overcome these problems according to prior art.

More precisely, one purpose of the invention is to provide compounds based on liquid crystals for making compounds based on liquid crystals and polymer matrices, these compounds having properties that are stable over a wide temperature range.

Another purpose of the invention is to provide such compounds based on liquid crystals and polymer matrices with good compatibility between liquid crystals and the polymer matrix.

Another purpose of the invention is to provide such compounds with wide attenuation ranges.

Another purpose of the invention is to provide such compounds with a sufficiently low value of the PDL parameter.

Another purpose of the invention is to provide such compounds with a slow response time.

Another purpose of the invention is to use such a technique that is simple and inexpensive.

### ESSENTIAL CHARACTERISTICS OF THE INVENTION

These purposes, and others that will become clearer later, are achieved by means of liquid crystal based compounds for making optoelectronic components that, according to the invention, comprise at least one cyanoester and at least one isothiocyanatobiphenyl and at least one monomer.

Thus, the invention is based on a quite new and inventive approach towards liquid crystal based compounds. These compounds are used to make compounds based on liquid crystals and polymer matrices that have stable properties over a wide range of temperatures and that have good compatibility between liquid crystals and polymer matrices.

Therefore, the invention relates particularly to a combination of a mix of liquid crystals maintaining its electro-optical properties over a wide temperature range, with at least one compatible monomer that can be used to make a composite PDLC type component for which the thermal properties are similar to the thermal properties of the pure mix of liquid crystals.

Consequently, the composite compound uses compounds, particularly liquid crystal based compounds, with these properties.

In particular, the invention relates to a combination (particularly with an appropriate choice of concentrations) and a particular compatibility of these two compounds (liquid crystals and monomers) to satisfy specifications in force in an optical communications environment; from the point of view of the temperature, and also dependence on polarisation and response times.

Advantageously, such a compound comprises at least two distinct cyanoesters and/or at least two distinct isothiocyanatobiphenyls.

Preferably, the cyanoester(s) belongs (belong) to the group of cyanoesters comprising:
4-cyanophenyl 4-alkylbenzoates;
4-cyanobiphenylyl 4-alkylbenzoates;
4-cyanophenyl 4-alkylbiphenylates;
4-cyanobiphenylyl 4-alkoxybenzoates;
4-cyanobiphenylyl 4-alkylbiphenylates;

Advantageously, such a compound comprises the five cyanoesters in the cyanoesters group.

Furthermore, and preferably, the isothiocyanatobiphenyl(s) belongs (belong) to the group of isothiocyanatobiphenyls comprising:
4′ alkyl isothiocyanatobiphenyls;
1-(4-alkylbiphenylyl)2-(4-isothiocyanatophenyl)ethanes.

According to one preferred embodiment, such a compound comprises a mix including at least the five cyanoesters and the two isothiocyanatobiphenyls mentioned above.

Advantageously, such a compound comprises at least one monomer.

Preferably, the monomer(s) belongs (belong) to the group including:
polyester acrylate resins;
triacrylate trimethylpropane;
ethylhexylacrylate.

According to one advantageous characteristic, such a compound includes a photoinitiator.

Advantageously, such a compound comprises the following by weight:
3% to 20% of 4-cyanophenyl 4-alkylbenzoates;
3% to 20% of 4-cyanobiphenylyl 4-alkylbenzoates;
3% to 20% of 4-cyanophenyl 4-alkylbiphenylates;
3% to 20% of 4-cyanobiphenylyl 4-alkoxybenzoates;
1% to 10% of 4-cyanobiphenylyl 4-alkylbiphenylates;
6% to 30% of 4′-alkyl 4-isothiocyanatobiphenyl;
3% to 20% of 1-(4-alkylbiphenylyl)2-(4-isothiocyanatophenyl)ethane;
1% to 30% of polyester acrylate resin;
0% to 10% of triacrylate trimethylpropane;
17% to 93% of ethylhexylacrylate;
0% to 3% of photoinitiator.

The invention also relates to a process for making a liquid crystal based compound for the manufacture of optoelectronic components, comprising a step in which at least one cyanoester, at least one isothiocyanatobiphenyl and at least one monomer are mixed.

Preferably, this manufacturing process comprises the following steps:
mix at least one cyanoester and at least one isothiocyanatobiphenyl, to produce a global mix;
solubilise the said liquid crystals in at least one monomer, so as to obtain an isotropic mix;
expose the said isotropic mix to electromagnetic radiation.

According to one advantageous characteristic, the intensity of the electromagnetic radiation is between 2 mW/cm² and 350 mW/cm².

According to one preferred embodiment, the mixing step includes the following steps:
first mix of liquid crystals including at least two of the following elements:
4-cyanophenyl 4-alkylbenzoates;
4-cyanobiphenylyl 4-alkylbenzoates;
4-cyanophenyl 4-alkylbiphenylates;
4-cyanobiphenylyl 4-alkoxybenzoates;
4-cyanobiphenylyl 4-alkylbiphenylates;
4′-alkyl 4-isothiocyanatobiphenyl;
1(4-alkylbiphenylyl)2-(4-isothiocyanatophenyl)ethane;
second mix of at least one monomer and/or at least one photoinitiator belonging to the group including:
polyester acrylate resins;
triacrylate trimethylpropane;
ethylhexylacrylate;
a photoinitiator;
mix of the said first mix and the said second mix.

According to one advantageous characteristic, the mixing step consists of the following mix by weight:
3% to 20% of 4-cyanophenyl 4-alkylbenzoates;
3% to 20% of 4-cyanobiphenylyl 4-alkylbenzoates;
3% to 20% of 4-cyanophenyl 4-alkylbiphenylates;
3% to 20% of 4-cyanobiphenylyl 4-alkoxybenzoates;
1% to 10% of 4-cyanobiphenylyl 4-alkylbiphenylates;
6% to 30% of 4′-alkyl 4-isothiocyanatobiphenyl;
3% to 20% of 1-(4-alkylbiphenylyl)2-(4-isothiocyanatophenyl)ethane;
1% to 30% of polyester acrylate resin;
0% to 10% of triacrylate trimethylpropane;
17% to 93% of ethylhexylacrylate;
0% to 3% of photoinitiator.

According to one preferred embodiment, this process includes a step to introduce the global mix or the said isotropic mix into a cell comprising two slides made of a transparent material.

The material from which the glass slides are made is transparent for the wavelengths used in the telecommunications field and also for UV, so that compounds according to the invention placed inside the cell can be subjected to UV electromagnetic radiation.

Advantageously, the cell is hermetically closed.

Thus, since the compounds according to the invention have not yet been submitted to radiation and are therefore still in the liquid phase, they are constrained to remain in the cell.

According to one preferred characteristic of the invention, at least one of the slides includes at least one layer of transparent conducting material on at least one of its faces.

Thus, in one particular embodiment, the two slides of the cell comprise one layer of such a material.

Advantageously, the thickness of the cell is between 15 μm and 20 μm.

According to one preferred embodiment of the invention, the solubilisation step comprises heating of the global mix.

According to one advantageous characteristic, heating is done at a temperature of between 20° C. and 180° C., for a duration of between 1 minute and 12 hours.

Advantageously, the exposure step uses ultraviolet light (UV) with a wavelength of between 340 nm and 400 nm.

According to one preferred embodiment of the invention, the wavelength is equal to approximately 365 nm.

Advantageously, the intensity of the UV light is between 2 mW/cm² and 350 mW/cm².

According to a first embodiment of the invention, the global mix contains 70% to 80% by weight of liquid crystals and the power of the UV light is between 15 mW/cm² and 100 mW/cm².

The result is PDLC type compounds.

According to a second embodiment of the invention, the global mix contains 60% to 70% by weight of liquid crystals, and the power of the UV light is between 100 mW/cm² and 350 mW/cm².

The result is nano-PDLC type compounds.

According to a third embodiment of the invention, the global mix contains 80% to 99% by weight of liquid crystals and the power of the UV light is between 100 mW/cm² and 350 mW/cm².

The invention also relates to optoelectronic components comprising at least one compound based on liquid crystals as described above and particularly but not exclusively those belonging to the group composed of:
optical attenuators;
optical equalisers;
polarisation controllers;
tuneable laser sources;
tuneable detectors;
tuneable filters.

### LIST OF FIGURES

Other characteristics and advantages of this invention will become clearer after reading the following description of a preferred embodiment given as a simple illustrative and non-limitative example, and the appended figures, wherein:

FIG. 1 shows a block diagram of steps in the process for manufacturing the compound based on liquid crystals according to a first embodiment of the invention;

FIG. 2 shows chemical formulas of the liquid crystals, included in the first embodiment of the first mix of the process according to the invention given with reference to FIG. 1;

FIG. 3 shows chemical formulas of families of liquid crystals used to make the said first mix;

FIG. 4 shows a block diagram of steps in the process for manufacturing the compound based on liquid crystals according to a second embodiment of the invention;

FIGS. 5A, 5B and 5C show graphs 60, 70 and 80 illustrating the variation of the attenuation range as a function of the temperature for compounds C1 and C2 according to the invention and for compound C3 respectively;

FIGS. 6A to 6D illustrate operation of the variable optical attenuation and the variable optical phase shift starting from a compound according to the invention;

FIG. 7 shows the diagram of a dynamic gain equaliser comprising a matrix of variable optical attenuators made using the compound according to the invention.

### DESCRIPTION OF ONE EMBODIMENT OF THE INVENTION (PREFERRED EMBODIMENT)

The general principle of the invention is based on a compound based on a mix of liquid crystals, a mix of monomers and photoinitiators with properties that remain stable over a wide temperature range. The compound also has good compatibility between liquid crystals and the polymer matrix. Finally, the compound when made in PDLC form has a wide range and low PDL and low response times.

### Process for Manufacturing the Compound According to a First Embodiment of the Invention (Corresponding to Your First Method)

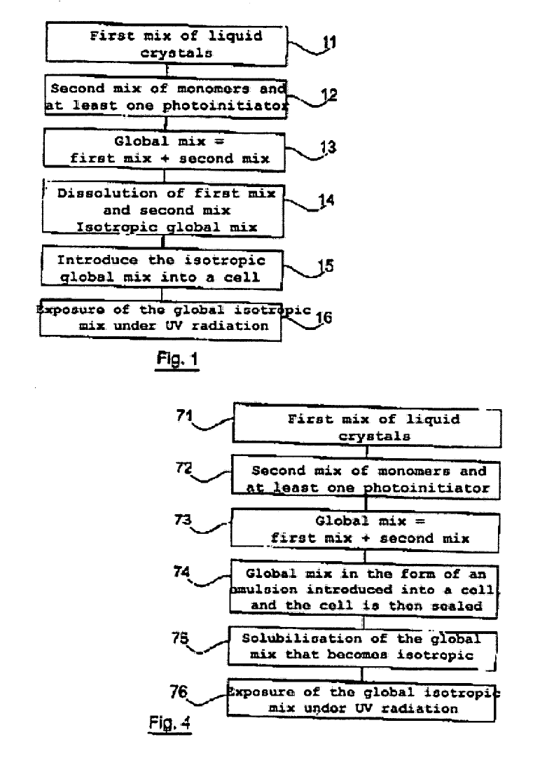

Steps in the process for manufacturing a compound based on liquid crystals according to a first embodiment of the invention are illustrated in FIG. 1.

A first step 11 includes production of a first mix of liquid crystals, comprising for example by weight:
6.30% of 4-cyanophenyl 4-ethylbenzoate;
6.30% of 4-cyanophenyl 4-propylbenzoate;
7.88% of 4-cyanobiphenylyl 4-pentylbenzoate;
7.88% of 4-cyanobiphenylyl 4-hexylbenzoate;
7.88% of 4-cyanophenylyl 4-pentylbiphenylate;
7.87% of 4-cyanophenylyl 4-heptylbiphenylate;
5.51% of 4-cyanobiphenylyl 4-pentyloxybenzoate;
5.51% of 4-cyanobiphenylyl 4-heptyloxybenzoate;
1.57% of 4-cyanobiphenylyl 4-pentylbiphenylate;
6.30% of 4-cyanobiphenylyl 4-heptylbiphenylate;
13.50% of 4′-ethyl 4-isothiocyanatobiphenyl;
13.50% of 4′-propyl 4-isothiocyanatobiphenyl;
5% of 1-(4-buthylbiphenylyl)2-(4-isothiocyanatophenyl)ethane;
5% of 1-(4-hexylbiphenylyl)2-(4-isothiocyanatophenyl)ethane.

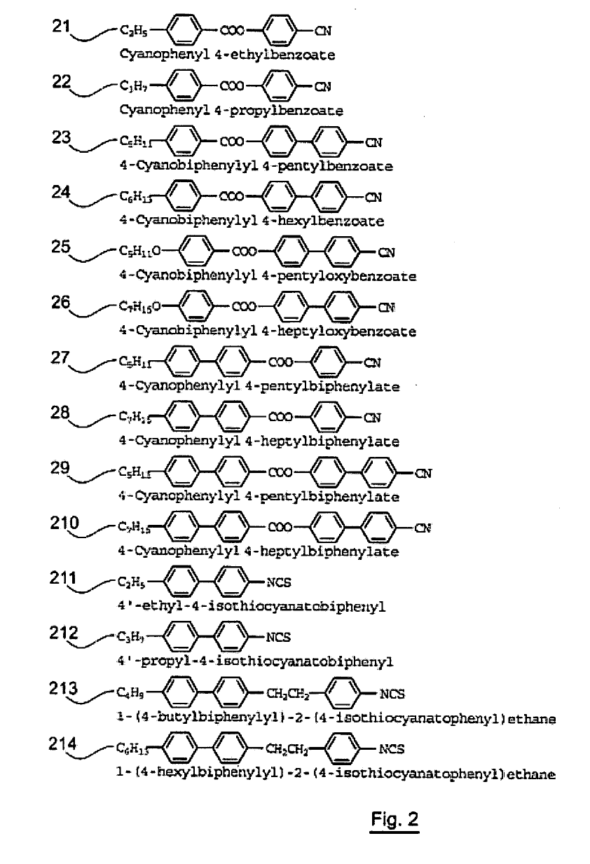

FIG. 2 shows chemical formulas for liquid crystals included in the first mix, as follows:
4-cyanophenyl 4-ethylbenzoate, in the family of 4-cyanophenyl 4-alkylbenzoates and marked as reference 21;
4-cyanophenyl 4-propylbenzoate, in the family of 4-cyanophenyl 4-alkylbenzoates and marked as reference 22;
4-cyanobiphenylyl 4-pentylbenzoate, in the family of 4-cyanobiphenylyl 4-alkylbenzoates and marked as reference 23;
4-cyanobiphenylyl 4-hexylbenzoate, in the family of 4-cyanobiphenylyl 4-alkylbenzoates and marked as reference 24;
4-cyanophenylyl 4-pentylbiphenylate, in the family of 4-cyanophenyl 4-alkylbiphenilates and marked as reference 25;
4-cyanophenylyl 4-heptylbiphenylate, in the family of 4-cyanophenyl 4-alkylbiphenilates and marked as reference 26;
4-cyanobiphenylyl 4-pentyloxybenzoate, in the family of 4-cyanobiphenylyl 4-alkoxybenzoates and marked as reference 27;
4-cyanobiphenylyl 4-heptyloxybenzoate, in the family of 4-cyanobiphenylyl 4-alkoxybenzoates and marked as reference 28;
4-cyanobiphenylyl 4-pentylbiphenylate, in the family of 4-cyanobiphenylyl 4-alkylbiphenylates and marked as reference 29;
4-cyanobiphenylyl 4-heptylbiphenylate, in the family of 4-cyanobiphenylyl 4-alkylbiphenylates and marked as reference 210;
4′-ethyl 4-isothiocyanatobiphenyl, in the family of 4′-alkyl 4-isothiocyanatobiphenyls and marked as reference 211;
4′-propyl 4-isothiocyanatobiphenyl, in the family of 4′-alkyl 4-isothiocyanatobiphenyls and marked as reference 212;
1-(4-butylbiphenylyl)2-(4-isothiocyanatophenyl)ethane, in the family of 1-(4-alkylbiphenylyl)2-(4-isothiocyanatophenyl)ethanes and marked as reference 213;
1-(4-hexylbiphenylyl)2-(4-isothiocyanatophenyl)ethane, in the family of 1-(4-alkylbiphenylyl)2-(4-isothiocyanatophenyl)ethanes and marked as reference 214;

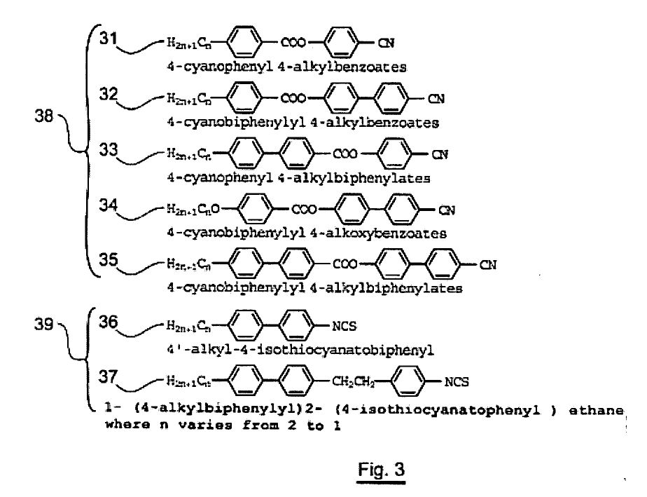

FIG. 3 shows typical chemical formulas in the families of liquid crystals mentioned above. For each family, the index n may be any integer value between 2 and 7. The first five families listed and referenced 31 to 35 are cyanoesters 38, while the last two families listed and referenced 36 and 37 are isothiocyanatobiphenyls 39.

A second step 12 consists of manufacturing a second mix of monomers and at least one photoinitiator such as Darocure 4265 made by Ciba (registered trademark) or Irgacure (registered trademark) marketed by the Ciba Company or any other photoinitiator.

The second mix of this second step may for example include:
8.3% by weight of polyester acrylate resin, and particularly Ebecryl (registered trademark) made by the UCB Company;
1.7% by weight of trimethylpropane triacrylate;
89.2% by weight of ethylhexylacrylate;
0.8% by weight of photoinitiator.

A third step 13 consists of manufacturing a global mix comprising the first mix and the second mix.

The choice of concentrations of constituents in the second mix and the concentration of liquid crystals (first mix) in the global mix provides a means of adjusting the parameters: range, PDL, response time and control voltage of the compound resulting from this process.

A fourth step 14 consists of dissolution of the first mix and the second mix by adjusting the temperature such that the resulting mix is in the isotropic phase. This condition must absolutely be satisfied to obtain a compound with the required characteristics and a satisfactory homogeneity.

A fifth step 15 consists of introduction of the isotropic global mix by capillarity into a cell composed of two glass slides. These glass slides each have one previously deposited layer of a transparent electrically conducting material which, in the context of this example, is indium and tin oxide (ITO) but which could be another equivalent material known to those skilled in the art. The compound in this step and in the next step is kept at the dissolution temperature of the fourth step making it isotropic. This conducting layer will make it possible to apply a potential difference to the compound later. The conducting layer may have been etched. A constant distance between the two slides is obtained by the use of small dispersion spacers with diameters of the order of a few microns to a few tens of microns (glass balls, polymer balls, or even an etched resin layer).

Note that the slides in the cell may be made from glass, but they could also be made from any other material that is both:
amorphous, or crystalline with a crystallographic orientation such that no birefringence of the substrate appears;
transparent within the telecommunication wavelengths range and the UV range, so that the polymerisation reaction can be initiated.

Such a material may be for example fluorine, silica, magnesium fluoride or any other appropriate material.

A sixth step 16 consists of exposure of the global isotropic mix under ultraviolet (UV) light with a wavelength within the range from 350 nm to 400 nm. Preferably, this wavelength may be equal to approximately 365 nm. This exposure provokes polymerisation of the mix of monomers.

During propagation of polymerisation, a phase separation takes place between the liquid crystal and the polymer. The choice of the exposure intensity, the concentrations of the different constituents and the manufacturing temperature provide a means of optimising the PDLC to obtain the required characteristics.

When making PDLC according to this first embodiment, the choice will be made on:
UV light intensity equal to approximately 100 mW/cm²;
liquid crystal concentration equal to approximately 74% by weight of the global mix;
dissolution temperature and holding in the isotropic phase equal to approximately 95° C. applied for a duration of between 2 and 5 minutes during the dissolution step.

When making nano-PDLC according to this first embodiment, the choice will be made on:
UV light intensity equal to approximately 200 mW/cm²;
liquid crystal concentration equal to approximately 68% by weight of the global mix;
dissolution temperature and holding in the isotropic phase equal to approximately 95° C. applied for a duration of between 2 and 5 minutes during the dissolution step.

Obviously, those skilled in the art could use any electromagnetic radiation source for the exposure step other than UV, such as radiation of visible or infrared light. They could even use an electron beam.

### Process for Making the Compound According to a Second Embodiment of the Invention (Corresponding to Your Second Method)

An important constraint on the different constituents of the global mix before exposure is that they must not be volatile. These constituents must not evaporate excessively at the cell production temperature to assure good reproducibility of their characteristics.

Thus, a second embodiment is envisaged in order to compensate for volatility of the monomer and to improve homogeneity of the compound.

The steps in a process for manufacturing the compound based on liquid crystals according to this second embodiment of the invention are illustrated in FIG. 4.

The first three steps 71, 72 and 73 of this second embodiment are identical to the first three steps 11, 12 and 13 in the first embodiment.

A fourth step 74 consists of introduction of the global mix in the form of an emulsion of liquid crystals into a mix of monomers and photoinitiators by capillarity, in a cell composed of two glass slides each with a previously deposited layer of a transparent electrically conducting material, particularly indium and tin oxide (ITO). This conducting layer will be used to apply a potential difference on the compound. The conducting layer may have been etched. A constant distance between the two slides is obtained by the use of small dispersion spacers with diameters of the order of a few microns to a few tens of microns (glass balls, polymer balls, or even an etched resin layer).

The cell is then hermetically sealed using a fast setting glue (for example such as epoxy glue or cyanoacrylate, or any other type of glue). Any other process could be used to seal the cell.

During a fifth step 75, the cell is placed in the second mix at a temperature exceeding the solubilisation temperature of the first mix of liquid crystals for a sufficient time such that the global mix is in an isotropic phase. This heat treatment must be applied for sufficiently long to assure good homogenisation of the liquid crystals—monomers mix in the cell (this treatment may take several hours depending on the compound used). Sealing of the cell (during the fourth step) is important to avoid any evaporation of the monomer mix during the homogenisation heat treatment.

The sixth step 76 is identical to the sixth step 16 in the first embodiment of the process described above and therefore is not described here.

When making PDLC according to this second embodiment, the choice will be made on:
UV light intensity equal to approximately 100 mW/cm²;
liquid crystal concentration equal to approximately 74% by weight of the global mix;
dissolution temperature and holding in the isotropic phase equal to approximately 95° C. applied for a duration of not less than 6 hours during the dissolution step.

When making nano-PDLC according to this second embodiment, the choice will be made on:
UV light intensity equal to approximately 200 mW/cm²;
liquid crystal concentration equal to approximately 68% by weight of the global mix;
dissolution temperature and holding in the isotropic phase equal to approximately 95° C. applied for a duration of at least 6 hours during the dissolution step.

Note that in general, evaporation of the mix of monomers may also be limited by the reduction in this mix of the percentage by weight of ethylhexylacrylate, which is the most volatile monomer. This reduction may be compensated by an increase of the percentage by weight of polyester acrylate that is the least volatile monomer, in this mix. Obviously, these reductions and increases in the corresponding percentages result in mixes respecting the proportions protected by the invention.

Compounds according to the embodiments described above are only example embodiments, and other mixes will be identified later.

### Examples of Characteristics Obtained as a Function of the Temperature

Two compounds C1 and C2 were produced according to the first embodiment of the process according to the invention illustrated in FIG. 1.

They include a first mix of liquid crystals for which the liquid crystal materials and their proportion by weight are as given as an example in the first step 11.

The second mix of compound C1 is as given as an example in the second step 12.

The second mix of compound C2 includes 10% by weight of polyester acrylate, 2% by weight of trimethylpropane, 87% by weight of ethylhexylacrylate and 1% by weight of photoinitiators.

Compounds C1 and C2 are PDLCs and comprise 74% and 76% respectively by weight of liquid crystals in the global mix. The compound C1 was made by adjusting the concentration of liquid crystals to obtain a good compromise corresponding to a sufficiently low value of the PDL parameter, a high value of the attenuation range, low response times and good stability of its properties with temperature.

A compound C3 was made using a process according to prior art. It comprises a first mix of liquid crystals marketed by the Merck Company (registered trademark) as reference TL205. The second mix of compound C3 is identical to the second mix of compound C2.

Compound C3 is a PDLC and comprises 76% by weight of liquid crystals in the global mix.

A series of measurement of the PDL parameter of compounds C1, C2 and C3 was made at 20° C. for an incident beam wavelength of 1550 nm, an incident beam diameter of 30 μm and 5 dB attenuation. The PDL values obtained are 0.3 dB for compound C1, 0.2 dB for compound C2 and 0.2 dB for compound C3.

The value of the PDL parameter for compound C3 is substantially identical to the value for compounds C1 and C2. These values are sufficiently low for the target applications.

A series of measurements of rise time and fall time parameters for compounds C1, C2 and C3 was made at 20° C. and at 60° C. Rise times of 6 s, 2 s and 8 s were measured at 20° C. for compounds C1, C2 and C3 respectively. Rise times of 1.6 s, 0.6 s and 3 s were measured at 60° C. for compounds C1, C2 and C3 respectively.

Fall times of 110 s, 108 s and 40 s were measured at 20° C. for compounds C1, C2 and C3 respectively. Fall times of 14 s, 17 s and 14 s were measured at 60° C. for compounds C1, C2 and C3 respectively.

Thus, rise times for compounds C1 and C2 according to the invention are shorter than rise times for compound C3 according to prior art, both at 20° C. and at 60° C. However, fall times for compounds C1 and C2 are approximately twice as long as fall times for compound C3 at 20° C. Fall times at 60° C. are comparable for the three compounds.

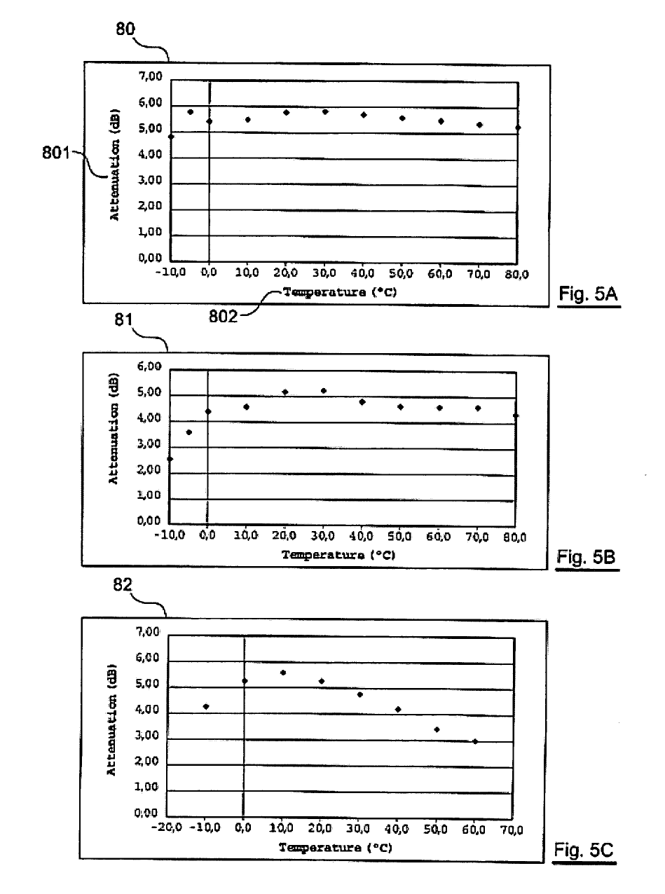

FIGS. 5A, 5B and 5C are graphs 80, 81 and 82 illustrating the variation of the attenuation range 801 in decibels as a function of the temperature 802 in 0° C., for compounds C1, C2 and C3 respectively.

The attenuation range 801 is measured over a temperature range 802 varying from −10° C. to 80° C. for the two compounds C1 and C2, and over a temperature range varying from −10° C. to 60° C. for compound C1.

Graph 80 shows that for compound C1, the attenuation range 801 remains satisfactory between 5 dB and 6 dB over the entire explored temperature range 802. Thus, the attenuation range 801 of compound C1 is relatively stable over a wide temperature range 802 varying from −10° C. to 80° C. For C2, graph 81 shows that once again the attenuation range 801 is relatively stable (around a value between 4 dB and 5 dB), over a temperature range 802 varying between approximately 10° C. and 80° C.

On the other hand, for compound C3, graph 82 shows that the attenuation range 801 drops dramatically on each side of its maximum value, between 5 dB and 6 dB, achieved at a temperature of 10° C. Therefore, a strong variation of the attenuation range parameter 801 is observed over the entire measured temperature range 802 (from −10° C. to 60° C.) for compound C3 according to prior art.

Thus, with compounds C1 and C2 according to the invention, the result is better temperature resistance of the attenuation range compared with compound C3 according to prior art, particularly towards high temperatures, which is an essential characteristic for the target applications.

The measurement of the temperature dependence (defined as being the average slope of the curve representing the attenuation range as a function of the temperature) for compounds C1, C2 and C3, gives approximately −0.01 dB/° C., −0.01 dB/° C. and −0.06 dB/° C. respectively between 20° C. and 60° C., and 0.03 dB/° C., 0.08 dB/° C and 0.03 dB/° C. respectively between −10° C. and 20° C. These measurements confirm that the attenuation range for compounds C1 and C2 according to the invention is more stable at high temperatures, than the corresponding attenuation range for compound C3 according to prior art.

### Example Applications of the Compound

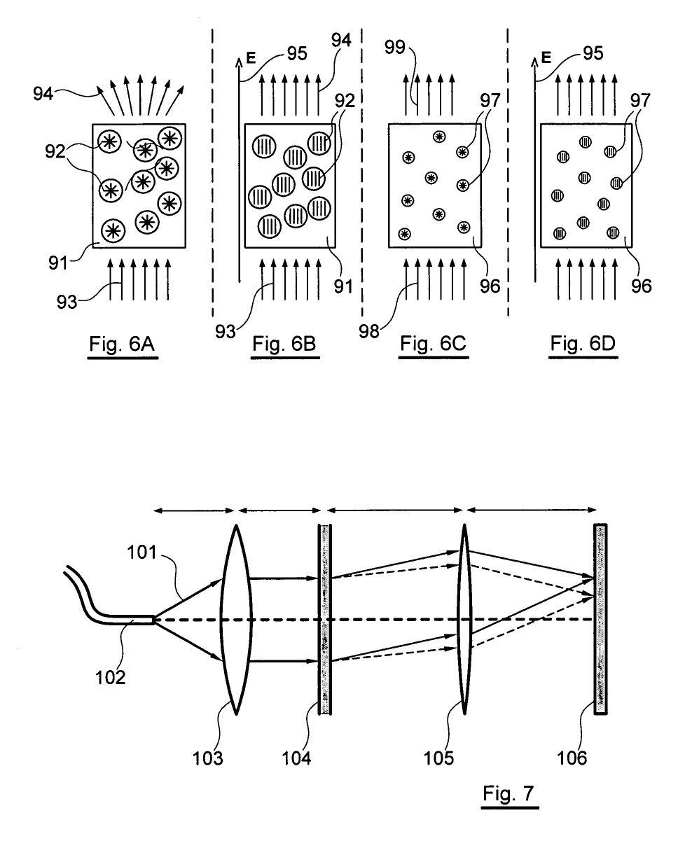

Operation of the variable optical attenuation and variable optical phase shift made using a compound according to the invention are illustrated in FIGS. 6A to 6D.

The variable optical attenuation illustrated in FIGS. 6A and 6B, uses a PDLC compound 91 for which the size of liquid crystal droplets 92 is large compared with the wavelength of an incident light wave 93. Thus, the light wave 93 sees liquid crystal droplets 92. If no electrical field is applied to the compound (FIG. 6A), this causes a diffusion phenomenon of the transmitted wave 94 that gradually disappears as an electrical field 95 denoted E (FIG. 6B) is applied. Therefore, for the PDLC 91, the incident wave 93 is attenuated if no electrical field is applied, and this incident wave is transmitted with little attenuation if a field 95 is applied. Therefore, the result is amplitude modulation of a transmitted wave 94 if the electrical field 95 applied to the PDLC 91 is modulated in advance.

The variable optical phase shift illustrated in FIGS. 6C and 6D uses a nano-PDLC compound 96 for which the size of liquid crystal droplets 97 is small compared with the wavelength of an incident light wave 98. In this case, the transmitted wave 99 is no longer diffused by the nano-PDLC compound 96 in the case in which no electrical field is applied to the compound 96, but the index of this compound 96 simply varies between the case with no applied electrical field (FIG. 6C) and the case with applied field 95 (FIG. 6D). This index variation depends on the amplitude of the applied field 95. Therefore, the result may be a phase modulation of the transmitted wave 99 if the electrical field 95 applied to the nano-PDLC 96 is modulated in advance.

Thus, variable optical attenuators (as specified in the patent document published as number FR2820827) and variable optical phase shifters can be made from PDLC and nano-PDLC cells according to the invention, respectively.

These attenuators or phase shifters can be made in the form of strips or matrices.

Furthermore, these variable optical attenuators or phase shifters based on the compound according to the invention may be used to make dynamic gain equalisers (DGE) or a dynamic channel equaliser (DCE).

FIG. 7 shows the diagram for a DGE made in free space. A light beam 101 comprising several wavelengths output from an optical fibre 102 passes through a first lens 103, is diffracted on a grating 104, passes through a second lens 105 and is then focused on a matrix 106 of variable optical attenuators. The spectrally modified beam 101 is then reflected and redirected to the fibre 102.

Obviously, those skilled in the art could use compounds according to the invention to make any optoelectronic component, and particularly but not exclusively:
optical attenuators;
optical equalisers;
polarisation controllers;
tuneable laser sources;
tuneable detectors;
tuneable filters.

1. Liquid crystal based compounds for making optoelectronic components, wherein it comprises at least one cyanoester, at least one isothiocyanatobiphenyl and at least one monomer.

2. Compound according to claim 1, wherein it comprises at least two distinct cyanoesters and/or at least two distinct isothiocyanatobiphenyls.

3. Compound according to claim 1, wherein the said cyanoester(s) belongs (belong) to the group of cyanoesters comprising:
4-cyanophenyl 4-alkylbenzoates;
4-cyanobiphenylyl 4-alkylbenzoates;
4-cyanophenyl 4-alkylbiphenylates;
4-cyanobiphenylyl 4-alkoxybenzoates;
4-cyanobiphenylyl 4-alkylbiphenylates.

4. Compound according to claim 3, wherein it comprises the five cyanoesters in the said cyanoesters group.

5. Compound according to claim 1, wherein the said isothiocyanatobiphenyl(s) belongs (belong) to the group of isothiocyanatobiphenyls comprising:
4′ alkyl 4-isothiocyanatobiphenyls;
1-(4-alkylbiphenylyl)2-(4-isothiocyanatophenyl)ethanes.

6. Compound according to claim 1, wherein comprises a mix comprising at least the 7 elements listed in claims 3 and 5.

7. Compound according to claim 1, wherein the said monomer(s) belongs (belong) to the group including:
polyester acrylate resins;
triacrylate trimethylpropane;
ethylhexylacrylate.

8. Compound according to claim 1, wherein it includes a photoinitiator.

9. Compound according to claim 1, wherein it comprises the following by weight:
3% to 20% of 4-cyanophenyl 4-alkylbenzoates;
3% to 20% of 4-cyanobiphenylyl 4-alkylbenzoates;
3% to 20% of 4-cyanophenyl 4-alkylbiphenylates;
3% to 20% of 4-cyanobiphenylyl 4-alkoxybenzoates;
1% to 10% of 4-cyanobiphenylyl 4-alkylbiphenylates;
6% to 30% of 4′-alkyl 4-isothiocyanatobiphenyl;
3% to 20% of 1-(4-alkylbiphenylyl)2-(4-isothiocyanatophenyl)ethane;
1% to 30% of polyester acrylate resin;
0% to 10% of triacrylate trimethylpropane;
17% to 93% of ethylhexylacrylate;
0% to 3% of photoinitiator.

10. Process for making a liquid crystal based compound for the manufacture of optoelectronic components,
wherein it comprises a step in which at least one cyanoester, at least one isothiocyanatobiphenyl and at least one monomer are mixed.

11. Process for making a compound according to claim 10, wherein it comprises the following steps:
mix at least one cyanoester and at least one isothiocyanatobiphenyl, to produce a global mix;
solubilise the said liquid crystals in at least one monomer, so as to obtain an isotropic mix;
expose the said isotropic mix to electromagnetic radiation.

12. Process for making a compound according to claim 11, wherein the intensity of the said electromagnetic radiation is between 2 mW/cm2 and 350 mW/cm2.

13. Process according to claim 10, wherein the said mixing step includes the following steps:
first mix of liquid crystals including at least two of the following elements:
4-cyanophenyl 4-alkylbenzoates;
4-cyanobiphenylyl 4-alkylbenzoates;
4-cyanophenyl 4-alkylbiphenylates;
4-cyanobiphenylyl 4-alkoxybenzoates;
4-cyanobiphenylyl 4-alkylbiphenylates;
4′-alkyl 4-isothiocyanatobiphenyl;
1-(4-alkylbiphenylyl)2-(4-isothiocyanatophenyl)ethane;
second mix of at least one monomer and/or at least one photoinitiator belonging to the group including:
polyester acrylate resins;
triacrylate trimethylpropane;
ethylhexylacrylate;
a photoinitiator;
mix of the said first mix and the said second mix.

14. Process for making a compound according to claim 13, wherein the said mixing step consists of the following mix by weight:
3% to 20% of 4-cyanophenyl 4-alkylbenzoates;
3% to 20% of 4-cyanobiphenylyl 4-alkylbenzoates;
3% to 20% of 4-cyanophenyl 4-alkylbiphenylates;
3% to 20% of 4-cyanobiphenylyl 4-alkoxybenzoates;
1% to 10% of 4-cyanobiphenylyl 4-alkylbiphenylates;
6% to 30% of 4′-alkyl 4-isothiocyanatobiphenyl;
3% to 20% of 1-(4-alkylbiphenylyl)2-(4-isothiocyanatophenyl)ethane;
1% to 30% of polyester acrylate resin;
0% to 10% of triacrylate trimethylpropane;
17% to 93% of ethylhexylacrylate;
0% to 3% of photoinitiator.

15. Process according to claim 10, wherein it includes a step to introduce the said global mix or the said isotropic mix into a cell comprising two slides made of a transparent material.

16. Process according to claim 15, wherein the said cell is hermetically closed.

17. Process according to claim 15, wherein at least one of the slides includes at least one layer of transparent conducting material on at least one of its faces.

18. Process according to claim 15, wherein the thickness of the said cell is between 15 μm and 20 μm.

19. Process according to claim 11, wherein the said solubilisation step comprises heating of the said global mix.

20. Process according to claim 19, wherein said heating is done at a temperature of between 20° C. and 180° C., for a duration of between 1 minute and 12 hours.

21. Process according to claim 11, wherein the said exposure step uses ultraviolet light with a wavelength of between 340 nm and 400 nm.

22. Process according to claim 21, wherein the said wavelength is equal to approximately 365 nm.

23. Process according to claim 21, wherein the intensity of the said UV light is between 2 mW/cm² and 350 mW/cm².

24. Process according to claim 21, wherein the said global mix contains 70% to 80% by weight of liquid crystals and in that the said power of the said UV light is between 15 mW/cm² and 100 mW/cm².

25. Process according to claim 21, wherein the said global mix contains 60% to 70% by weight of liquid crystals, and the power of the UV light is between 100 mW/cm² and 350 mW/cm².

26. Process according to claim 21, wherein the said global mix contains 80% to 99% by weight of liquid crystals and in that the said power of the said UV light is between 2 mW/cm² and 50 mW/cm².

27. Optoelectronic component comprising at least one compound based on liquid crystals according to claim 1, wherein it belongs to the group composed of:
optical attenuators;
optical equalisers;
polarisation controllers;
tuneable laser sources;
tuneable detectors;
tuneable filters.
